(19) United States
(12) Patent Application Publication
(10) Pub. No.: US 2026/0246155 A1
(43) Pub. Date: Aug. 20, 2026

(54) DIELECTRIC LENSES WITH LOW DIELECTRIC PROPERTIES

(71) Applicant: 3M INNOVATIVE PROPERTIES COMPANY, St. Paul, MN (US)

(72) Inventors: Jaewon Kim, Woodbury, MN (US); Jennifer J. Sokol, Mahtomedi, MN (US); Lars Schrix, Duisburg (DE); Elias Wilken-Resman, Minneapolis, MN (US); Ian Cummings, Brookfield, WI (US); Milo G. Oien-Rochat, Minneapolis, MN (US); Zohaib Hameed, Woodbury, MN (US)

(21) Appl. No.: 19/160,588

(22) PCT Filed: Mar. 5, 2024
(86) PCT No.: PCT/IB2024/052122

§ 371 Date: Aug. 28, 2025

Related U.S. Application Data
(60) Provisional application No. 63/451,674, filed on Mar. 13, 2023.

(51) Int. Cl. H01Q 15/08; H01Q 19/06

(52) U.S. Cl. CPC H01Q 15/08; H01Q 19/06

(57) ABSTRACT

A lens is configured to be disposed on spaced apart antenna elements of a phased array antenna. The lens includes a first major surface facing away from the elements and an opposite second major surface facing the elements, and opposite first and second end portions extending from the second major surface toward the first major surface and joining the first major surface by opposing first and second joining portions. The first and second major surfaces are substantially planar and parallel respective to a first and a second planar portion. When projected onto a reference plane parallel to the first and second planar portions, a ratio of a total projected area of the first planar portion to a projected area of the lens is at least 0.15, and a ratio of a total projected area of the second planar portion to the projected area of the lens is at least 0.1.

### SUMMARY

In some aspects of the present description, a lens is provided, the lens configured to be disposed on and substantially cover a plurality of spaced apart antenna elements of a phased array antenna. The lens includes a first major surface configured to face away from the antenna elements and an opposite second major surface configured to face the antenna elements. The first and second major surfaces have substantially planar and substantially parallel at least one first and at least one second planar portions, respectively. The lens further includes opposite first and second end portions extending from the second major surface toward the first major surface and joining the first major surface by opposing respective first and second joining portions. When projected onto a reference plane that is substantially parallel to the at least one first and the at least one second planar portions, a ratio of a total projected area of the at least one first planar portion to a projected area of the lens is at least 0.15, and a ratio of a total projected area of the at least one second planar portion to the projected area of the lens is at least 0.1.

In some aspects of the present description, a lens is provided, the lens configured to be disposed on and substantially cover a plurality of spaced apart antenna elements of a phased array antenna. The lens includes at least one substantially first planar surface portion defining at least one corresponding first reference plane and configured to face away from the antenna elements, and at least one substantially second planar surface portion defining at least one corresponding second reference plane and configured to face the antenna elements. For each of the first and second planar surface portions, when projected onto the reference plane corresponding to the planar surface portion, a ratio of a projected area of the planar surface portion to a projected area of the lens is at least 0.15. When projected onto a bisecting plane that is orthogonal to the reference plane and substantially bisects the lens, a ratio of a projected area of the planar surface portion to a projected area of the lens is at most 0.1.

In some aspects of the present description, a lens is provided, the lens configured to be disposed on and to substantially cover a plurality of spaced apart antenna elements of a phased array antenna. The lens includes opposing first and second major surfaces, such that in each of mutually orthogonal first and second cross-sectional planes that substantially bisect the lens along mutually orthogonal respective first and second directions, the first and second major surfaces are substantially parallel with each other.

In some aspects of the present description, an antenna assembly is provided, the antenna assembly including a phased array antenna having a plurality of spaced apart antenna elements arranged in a plurality of rows and columns of the antenna elements and defining a first axis of symmetry, and a lens disposed on the phased array antenna and substantially covering at least some of the antenna elements. In a scan plane that includes the first axis of symmetry and a normal to the phased array antenna, the antenna assembly steers respective p- and s-polarized beams in the scan plane having respective maximum gains G1p and G1s when steered along a first direction making an angle of less than about 10 degrees with the normal and respective maximum gains G2p and G2s when steered along a second direction making an angle of no less than about 30 degrees with the normal. G2s is less than G1s by at most about 1 dB and G2p is less than G1p by at least than about 1 dB.

In some aspects of the present description, a lens is provided, the lens configured to be disposed on and substantially cover a phased array antenna that includes a plurality of spaced apart antenna elements arranged in a plurality of rows and columns and which defines a first axis of symmetry. The lens includes at least one substantially first planar surface portion configured to face away from the antenna elements and at least one substantially second planar surface portion configured to face the antenna elements. Each of at least one of the at least one substantially first planar surface portion and at least one of the at least one substantially second planar surface portion are sufficiently large to cover at least a two-by-two array of the antenna elements. When the lens is disposed on the phased array antenna, then for an s-polarized beam steered in a scan plane that includes the first axis of symmetry and a normal to the phased array antenna and for scan angles in a first scan angle range extending from about zero degrees to at least about 35 degrees, a maximum gain of the s-polarized steered beam has an average value Gavg and a standard deviation Gstd such that Gstd/Gavg is less than or equal to 0.04.

### BRIEF DESCRIPTION OF THE DRAWINGS

FIG. 1 is a top view of a phased array antenna including a lens, in accordance with an embodiment of the present description;

FIG. 2 is a side, cutaway view of a phased array antenna including a lens, in accordance with an embodiment of the present description;

FIGS. 3A and 3B provide perspective and side views, respectively, of a lens for a phased array antenna, in accordance with an embodiment of the present description;

FIGS. 4A and 4B provide top and bottom views, respectively, of a lens for a phased array antenna, in accordance with an embodiment of the present description;

FIGS. 5A and 5B provide cutaway views of a lens for a phased array antenna, in accordance with an embodiment of the present description;

FIG. 6 is a perspective view of a phased array antenna including a lens, in accordance with an embodiment of the present description;

FIGS. 7A and 7B provide plots for maximum gain versus scan angle for a phased array antenna including a lens, in accordance with an embodiment of the present description; and

FIGS. 8A and 8B provide plots for maximum gain and beam width versus scan angle for a phased array antenna including a lens, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the term “between about”, unless otherwise specifically defined, generally refers to an inclusive or a closed range. For example, if a parameter X is between about A and B, then A≤X≤B.

As used herein, “gain” of an antenna is a measure of a maximum effectiveness with which the antenna can radiate a unit of power delivered to it by a transmitter towards a target.

As used herein, “antenna boresight” is an axis of maximum antenna gain or maximum radiated power of a directional antenna.

As used herein, “scan angle” represents an angle from an antenna boresight in which the main lobe of the radiation pattern is steered. It can be defined according to a “maximum gain,” “3 dB midpoint,” or other criteria based on the radiation pattern characteristics.

As used herein, “scan range” represents the range of scan angles that can be obtained through appropriate phasing of the antenna array.

As used herein, “loss tangent” quantifies a dielectric material's inherent dissipation of electromagnetic energy. Specifically, the loss tangent is a ratio of resistive and reactive components of a system.

As part of upgrading current mobile network infrastructure to provide 5th Generation (5G) voice and data services, millimeter wave (mmWave) phased array antennas are nowadays being installed on existing Radio Access Network (RAN) cell sites. These cell sites typically support three sector antenna arrays, each of the three sector antenna arrays providing 120 degrees azimuthal coverage within the cell sites. In combination, the three sector antennas provide 360 degrees azimuthal coverage within the cell sites, thereby providing an omnidirectional coverage within the cell sites.

In order to provide a same network coverage within the existing RAN cell sites, highly directive mmWave antennas are used. The highly directive mmWave antennas include one or a small number of phased arrays and each phased array further includes a large number of radiating elements. However, the highly directive mmWave antennas may limit an azimuthal scan range of an overall antenna assembly due to beam broadening. The beam broadening may occur when the phased arrays broadcast further from an antenna boresight, i.e., at wider azimuthal scan angles. Therefore, the mmWave phased arrays may not provide 120 degrees coverage without a significant gain degradation at the wider azimuthal scan angles. This may lead to a decreased network coverage at seams (i.e., at wider azimuthal scan angles) of the cell sites. Thus, additional cell sites may be required to provide the same network coverage as the existing RAN cell sites.

The present disclosure provides an antenna assembly. The antenna assembly includes a phased array antenna including a plurality of spaced apart antenna elements arranged in a plurality of rows and columns of the antenna elements and defining a first axis of symmetry. The antenna assembly further includes a lens as described herein disposed on the phased array antenna and substantially covering at least some of the antenna elements.

According to some aspects of the present description, a lens is configured to be disposed on and substantially cover a plurality of spaced apart antenna elements of a phased array antenna (e.g., a millimeter-wave, or mmWave, phased-array antenna). In some embodiments, the lens may include a first major surface configured to face away from the antenna elements and an opposite second major surface configured to face the antenna elements. In some embodiments, the first and second major surfaces may include at least one first planar portion and at least one second planar portions, respectively, such that the at least one first planar portion and the at least one second planar portion are substantially planar and substantially parallel. In some embodiments, the lens may further include opposite first and second end portions extending from the second major surface toward the first major surface and joining the first major surface by opposing respective first and second joining portions.

In some embodiments, when the lens is projected onto a reference plane (e.g., an xy-plane of the lens, such as the plane containing the antenna elements) that is substantially parallel to the at least one first and the at least one second planar portions, then a ratio of a total projected area of the at least one first planar portion to a projected area of the lens is at least 0.15, or at least 0.2, or at least 0.25, or at least 0.3, or at least 0.35, or at least 0.4, or at least 0.45, or at least 0.5, and a ratio of a total projected area of the at least one second planar portion to the projected area of the lens is at least 0.1, or at least 0.015, or at least 0.2, or at least 0.25, or at least 0.3, or at least 0.35, or at least 0.4, or at least 0.45, or at least 0.5.

In some embodiments, wherein the ratio of the total projected area of the at least one second planar portion to the projected area of the second major surface is at least 0.8, or at least 0.85, or at least 0.90, or at least 0.95, or at least 0.98, or at least 0.99. In some embodiments, the ratio of the total projected area of the at least one first planar portion to the projected area of the first major surface is at most 0.9, or at most 0.85, or at most 0.8, or at most 0.75, or at most 0.7, or at most 0.65, or at most 0.6.

In some embodiments, the ratio of the total projected area of the at least one first planar portion to the projected area of the first major surface is at least 0.8, or at least 0.85, or at least 0.90, or at least 0.95, or at least 0.98, or at least 0.99. In some embodiments, the total projected area of the at least one first planar portion is less than the total projected area of the at least one second planar portion. In some embodiments, the total projected area of the at least one first planar portion and the total projected area of the at least one second planar portion are within 30%, or within 25%, or within 20%, or within 15%, or within 10%, or within 5% of each other.

In some embodiments, the first and second major surfaces may define a height direction (e.g., a z-axis extending orthogonal to the plane of the antenna elements) of the lens therebetween, and wherein the first and second end portions define a length direction (e.g., an x-axis extending between first and second end portions) of the lens therebetween. In some such embodiments, the length and height directions may be orthogonal to each other. In some embodiments, a maximum height of the lens along the height direction may be less than a maximum length of the lens along the length direction.

In some embodiments, the lens may further include opposing first and second side portions extending between the first and second major surfaces and between the first and second end portions, wherein the first and second side portions are substantially planar and substantially parallel to each other. In some embodiments, the first and second side portions may define a width direction (e.g., along a y-axis) of the lens therebetween orthogonal to the height and length directions. In some embodiments, a maximum width of the lens along the width direction may be less than a maximum length of the lens along the length direction.

In some embodiments, the phased array antenna may be configured to emit a beam at an operating frequency in a range from about 0.5 GHz to about 400 GHz. In some such embodiments, a dielectric constant of the lens is in a range from 1.2 to about 7, or from 1.4 to about 3, or from about 1.49 to about 2 at the operating frequency.

In some embodiments, the phased array antenna may be configured to emit a beam at an operating wavelength, wherein each of the first and second joining portions is curved having a radius of curvature. In some such embodiments, the radius of curvature may be between about 1.5 times the operating wavelength to about 3 times the operating wavelength. In some embodiments, for example, the radius of curvature may be about 2.5 times the operating wavelength.

According to some aspects of the present description, a lens is configured to be disposed on and substantially cover a plurality of spaced apart antenna elements of a phased array antenna. In some embodiments, the lens may include at least one substantially first planar surface portion defining at least one corresponding first reference plane (e.g., a plane parallel to an xy-plane of the lens) and configured to face away from the antenna elements, and at least one substantially second planar surface portion defining at least one corresponding second reference plane (e.g., a plane parallel to the xy-plane) and configured to face the antenna elements.

In some embodiments, for each of the first and second planar surface portions, when projected onto the reference plane corresponding to the first or second planar surface portion, a ratio of a projected area of the planar surface portion to a projected area of the lens may be at least 0.15, or at least 0.2, or at least 0.25, or at least 0.3, or at least 0.35, or at least 0.4, or at least 0.45, or at least 0.5, and when projected onto a bisecting plane that is orthogonal to the reference plane and substantially bisects the lens (e.g., a bisecting plane parallel to the width direction of the lens, or a bisecting plane parallel to the length direction of the lens), a ratio of a projected area of the planar surface portion to a projected area of the lens may be at most 0.1, or at most 0.05, or at most 0.01, or at most 0.005, or at most 0.001. In some such embodiments, for each of the first and second planar surface portions, when projected onto the bisecting plane, the projected area of the planar surface portion onto the bisecting plan may be substantially zero.

According to some aspects of the present description, a lens is configured to be disposed on and substantially cover a plurality of spaced apart antenna elements of a phased array antenna. In some embodiments, the lens may include opposing first and second major surfaces, such that in each of mutually orthogonal first and second cross-sectional planes that substantially bisect the lens along mutually orthogonal respective first (e.g., the x-axis) and second (e.g., the y-axis) directions, the first and second major surfaces may be substantially parallel with each other.

In some embodiments, in at least one of the first and second cross-sectional planes, the first and second major surfaces may be curved. In some embodiments, in one of the first and second cross-sectional planes, the first and second major surfaces are curved, and in the other one of the first and second cross-sectional planes, the first and second major surfaces are substantially straight lines.

In some embodiments, in each of the first and second cross-sectional planes, a length of a line that extends between, and is normal to at least one of, the first and second major surfaces, varies by less than 20%, or less than 15%, or less than 10%, or less than 5% across at least of the first and second major surfaces.

In some embodiments, the phased array antenna may be configured to emit a beam at an operating wavelength corresponding to an operating frequency in a range from about 0.5 GHz to about 400 GHz, and the length may be in a range from about 1.5 times the operating wavelength to about 5 times the operating wavelength. In some embodiments, the operating wavelength may be a free-space operating wavelength. In some embodiments, the operating wavelength may be an operating wavelength in a medium other than air. In some embodiments, the length is a half-integer multiple of the operating wavelength.

In some embodiments, the first major surface may include at least one substantially first planar surface portion, and wherein when projected onto the second cross-sectional plane, a ratio of a projected area of the at least one substantially first planar surface portion to a projected area of the first major surface is at least 0.15, or at least 0.2, or at least 0.25, or at least 0.3, or at least 0.35, or at least 0.4, or at least 0.45, or at least 0.5. In some embodiments, the second major surface may include at least one substantially second planar surface portion, and wherein when projected onto the second cross-sectional plane, a ratio of a projected area of the at least one substantially second planar surface portion to a projected area of the second major surface is at least 0.25, or at least 0.2, or at least 0.25, or at least 0.3, or at least 0.35, or at least 0.4, or at least 0.45, or at least 0.5, or at least 0.6, or at least 0.7, or at least 0.8, or at least 0.9.

According to some aspects of the present description, an antenna assembly may include a phased array antenna and a lens. In some embodiments, the phased array antenna may include a plurality of spaced apart antenna elements arranged in a plurality of rows and columns of the antenna elements and defining a first axis of symmetry. In some embodiments, the lens may be disposed on the phased array antenna and may substantially cover at least some of the antenna elements.

In some embodiments, in a scan plane that includes the first axis of symmetry and a normal (e.g., along the z-axis) to the phased array antenna, the antenna assembly may steer respective p- and s-polarized beams in the scan plane having respective maximum gains G1p and G1s when steered along a first direction making an angle of less than about 10 degrees, or less than about 8 degrees, or less than about 6 degrees, or less than about 4 degrees, or less than about 2 degrees, or less than about 1 degree (e.g., about 0 degrees) with the normal and respective maximum gains G2p and G2s when steered along a second direction making an angle of no less than about 30 degrees, or no less than 35 degrees, or no less than 40 degrees with the normal, G2s may be less than G1s by at most about 1 dB, or at most about 0.9 dB, or at most about 0.8 dB, or at most about 0.7 dB, or at most about 0.6 dB, or at most about 0.5 dB, or at most about 0.4 dB, or at most about 0.3 dB, or at most about 0.2 dB, or at most about 0.1 dB (e.g., about 0.4 dB) and G2p may be less than G1p by at least about 1 dB, or by at least about 1.5 dB, or by at least about 2 dB, or by at least about 2.5 dB, or by at least about 2.6 dB, or by at least about 3 dB, or by at least about 4 dB, or by at least about 5 dB, or by at least about 6 dB, or by at least about 7 dB (e.g., about 4 dB).

In some embodiments, the phased array antenna may be configured to emit a beam at an operating wavelength corresponding to an operating frequency in a range from about 0.5 GHz to about 400 GHz, wherein an average spacing between the lens and the spaced apart antenna elements of the phased array antenna may between about 5% and about 100% of the operating wavelength in a free-space. In some embodiments, an average spacing between the lens and the spaced apart antenna elements of the phased array antenna may be between about 0.01 mm and about 100 mm, or between about 1 mm to about 10 mm.

According to some aspects of the present description, a lens may be configured to be disposed on and substantially cover a phased array antenna that includes a plurality of spaced apart antenna elements arranged in a plurality of rows and columns and which defines a first axis of symmetry. In some embodiments, the lens may include at least one substantially first planar surface portion configured to face away from the antenna elements and at least one substantially second planar surface portion configured to face the antenna elements. In some embodiments, each of at least one of the at least one substantially first planar surface portion and at least one of the at least one substantially second planar surface portion may be sufficiently large to cover at least a two-by-two array of the antenna elements.

In some embodiments, when the lens is disposed on the phased array antenna, then for an s-polarized beam steered in a scan plane that includes the first axis of symmetry and a normal to the phased array antenna, and for scan angles in a first scan angle range extending from about zero degrees to at least about 35 degrees, or at least about 40, or at least about 45 degrees, a maximum gain of the s-polarized steered beam may have an average value Gavg and a standard deviation Gstd, such that the ratio Gstd/Gavg is less than or equal to about 0.04, or less than or equal to about 0.035, or less than or equal to about 0.03, or less than or equal to about 0.025, or less than or equal to about 0.02, or less than or equal to about 0.015, or less than or equal to about 0.01.

In some embodiments, when the lens is disposed on the phased array antenna, then for a p-polarized beam steered in the scan plane and for scan angles in the first scan angle range, a plot of a beam width of the p-polarized steered beam as a function of the scan angle has a first beam width Wp1 at a smaller first scan angle of greater than about 5 degrees, or greater than about 10 degrees, or greater than about 15 degrees, and a second beam width Wp2 at a larger second scan angle of greater than about 20 degrees, or greater than about 25 degrees, or greater than about 30 degrees, or greater than about 35 degrees, Wp1 may be greater than Wp2 by at least 5 degrees, or at least 6 degrees, or at least 7 degrees, or at least 8 degrees, or at least 9 degrees, or at least 10 degrees.

In some embodiments, in the first scan angle range, the first beam width Wp1 at the smaller first scan angle may be a global maximum of the plot of the beam width of the p-polarized steered beam as a function of the scan angle.

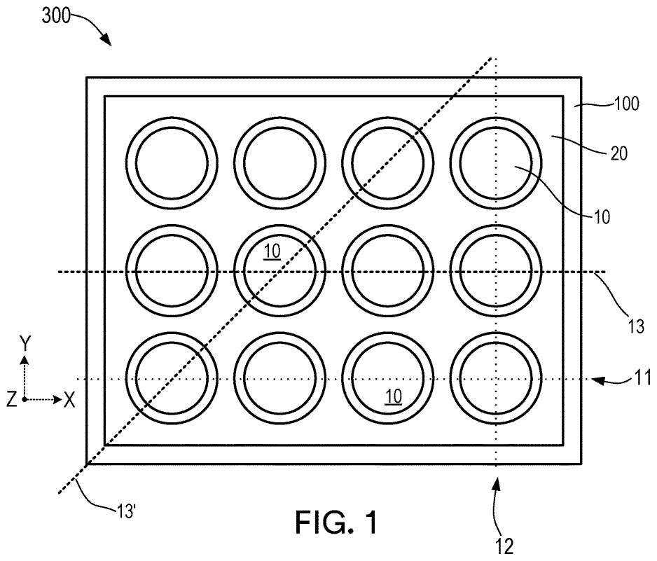

Turning now to the figures, FIG. 1 is a top view of an embodiment of a phased array antenna including a lens, according to the present description. Antenna assembly 300 includes a phased array antenna 100 and a lens 20. In some embodiments, the phased array antenna 100 may include a plurality of spaced apart antenna elements 10 arranged in a plurality of rows 11 and columns 12 of the antenna elements 10 and defining a first axis of symmetry 13.

In some embodiments, lens 20 may be disposed on phased array antenna 10 and may substantially cover at least some of the antenna elements 10. As shown in FIG. 1, lens 20 is shown as an outline (i.e., a rectangular outline) and can be assumed to be covering at least some of antenna elements 10. Additional details on lens 20 can be found elsewhere herein.

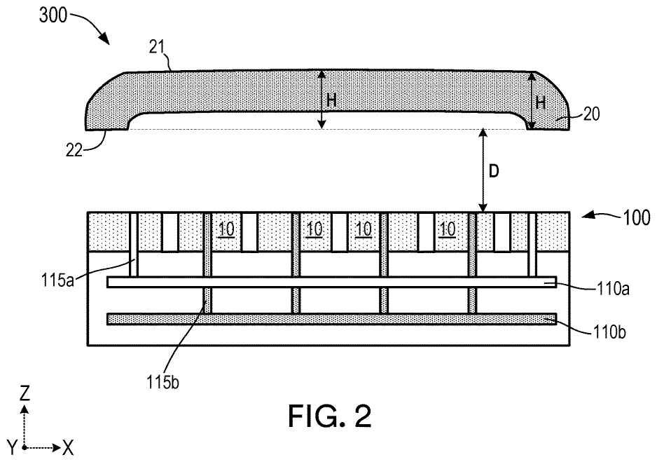

FIG. 2 provides an alternate view of antenna assembly 300, which is a side, cutaway view. As shown by the legends in both FIGS. 1 and 2, the antenna elements 10 are arranged in rows 11 and columns 12 in an x-y plane of the antenna assembly 300, and lens 20 defines a height H in the z-axis above the antenna assembly 300. In some embodiments, antenna assembly 300 further defines a spacing D, representative of an average spacing between the lens 20 and the spaced-apart antenna elements 10. In some embodiments, the average spacing D may be between about 0.01 mm and about 100 mm, or between about 1 mm to about 10 mm. In some embodiments, antenna elements 10 may be connected to one or more ground planes 110a, 110b by one or more electrically conductive vias 115a, 115b.

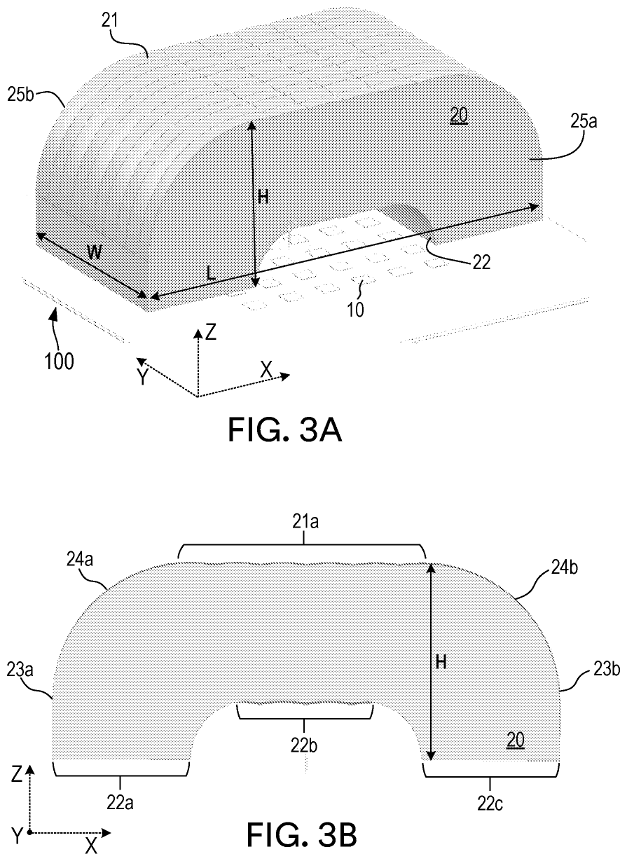

In some embodiments, lens 20 includes a first major surface 21 configured to face away from antenna elements 10 and an opposite second major surface 22 configured to face antenna elements 10, In some embodiments, the first 21 and second 22 major surfaces may have substantially planar and substantially parallel respective at least one first and at least one second planar portions, discussed elsewhere herein, at least in the description of FIG. 3B.

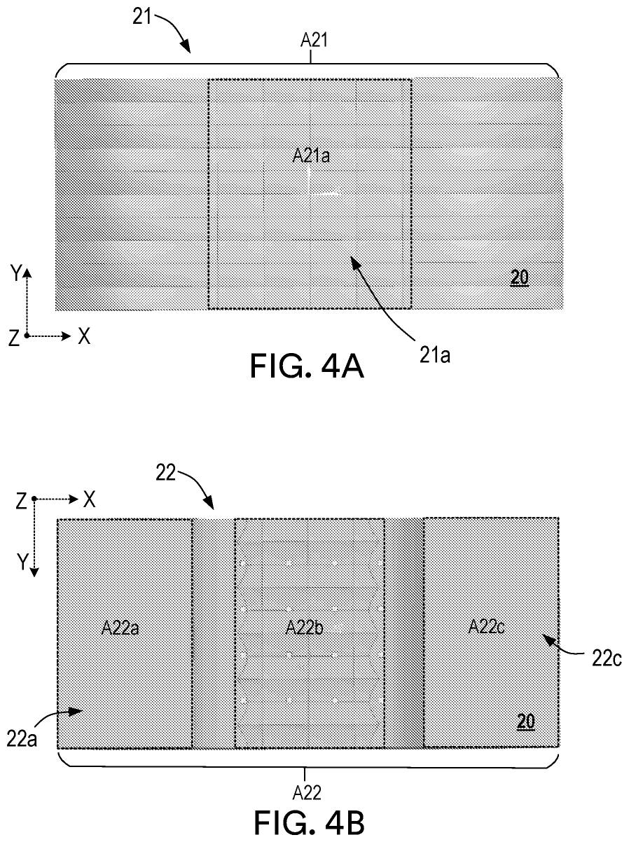

FIGS. 3A and 3B provide perspective and side views, respectively, of an embodiment of a lens for a phased array antenna, such as phased array antenna 100 of FIGS. 1 and 2. FIGS. 4A and 4B provide top and bottom views, respectively, of an embodiment of a lens for a phased array antenna such as the embodiment of FIGS. 3A and 3B. For the following discussion, FIGS. 3A, 3B, 4A, and 4B will be referenced together.

In some embodiments, a lens 20 may be configured to be disposed on and substantially cover a plurality of spaced apart antenna elements 10 of a phased array antenna 100. In some embodiments, the lens may include a first major surface 21 (e.g., a “top” surface, based on the z or thickness direction shown at least in FIG. 3A) configured to face away from antenna elements 10 and an opposite second major surface 22 (e.g., a “bottom” surface) configured to face antenna elements 10. In some embodiments, the first major surface 21 and second major surface 22 may include at least one first planar portion 21a (see at least FIG. 3B) and at least one second planar portion 22a, 22b, 22c, respectively. In some embodiments, the at least one first planar portion 21a and the at least one second planar portion 22a, 22b, 22c may be substantially planar and substantially parallel to each other.

In some embodiments, lens 20 may further include opposite first 23a and second 23b end portions extending from second major surface 22 toward first major surface 21 and joining the first major surface 21 by opposing respective first 24a and second 24b joining portions. In some embodiments, the first 21 and second 22 major surfaces define a height direction (e.g., the z-axis of FIG. 3A) of lens 20 therebetween, and first 23a and second 23b end portions define a length direction (e.g., the x-axis) of lens 20 therebetween. In some embodiments, the length and height directions are orthogonal to each other. In some embodiments, a maximum height H of lens 20 along the height direction may be less than a maximum length L of lens 20 along the length direction.

In some embodiments, lens 20 may further include opposing first side portion 25a and second side portion 25b extending between the first 21 and second 22 major surfaces and between the first 23a and second 23b end portions. In some embodiments, first 25a and second 25b side portions may be substantially planar and substantially parallel to each other. In some embodiments, first 25a and second 25b side portions may define a width direction (e.g., the y-axis of FIG. 3A) of lens 20 therebetween which is orthogonal to the height and length directions. In some such embodiments, a maximum width W of lens 20 along the width direction may be less than maximum length L of lens 20 along the length direction.

The at least one first planar portion 21a shown in FIG. 3B and at least one second planar portion(s) 22a, 22b, 22c and the areas which they may define in some embodiments are better seen in FIGS. 4A and 4B. FIG. 4A is a top plan view of lens 20 showing first major surface 21 and first planar portion 21a. As seen in plan view, first major surface 21 defines projected area A21 and first planar portion 21a defines a projected area A21a (shown as a dashed rectangle in FIG. 4A).

FIG. 4B is a bottom plan view of lens 20 showing second major surface 22 and second planar portions 22a, 22b, and 22c. As seen in this plan view from the bottom, second major surface 22 defines projected area A22, second planar portion 22a defines a projected area A22a, second planar portion 22b defines a projected area A22b, and second planar portion 22c defines a projected area A22c. In the embodiment of FIGS. 4A and 4B, lens 20 has a single top planar portion 21a and three separate bottom planar portions 22a, 22b, and 22c.

In some embodiments, when projected onto a reference plane that is substantially parallel to the at least one first 21a and the at least one second 22a, 22b, 22c planar portions (e.g., the xy-plane shown in FIGS. 4A and 4B), a ratio of a total projected area A21a of the at least one first planar portion 21a to a projected area A21 of the lens 20 may be at least 0.15, or at least 0.2, or at least 0.25, or at least 0.3, or at least 0.35, or at least 0.4, or at least 0.45, or at least 0.5 (see FIG. 4A), and a ratio of a total projected area A22a+A22b+A22c of the at least one second planar portion(s) to the projected area of the lens A22 is at least 0.1, or at least 0.015, or at least 0.2, or at least 0.25, or at least 0.3, or at least 0.35, or at least 0.4, or at least 0.45, or at least 0.5 (see FIG. 4B).

In some embodiments, the ratio of the total projected area A22a+A22b+A22c of the at least one second planar portion 22a to the projected area A22 of the second major surface 22 may be at least 0.8, or at least 0.85, or at least 0.90, or at least 0.95, or at least 0.98, or at least 0.99. In some embodiments, the ratio of the total projected area A21a of the at least one first planar portion 21a to the projected area A21 of the first major surface 21 may be at most 0.9, or at most 0.85, or at most 0.8, or at most 0.75, or at most 0.7, or at most 0.65, or at most 0.6. In some embodiments, the ratio of the total projected area A21a of the at least one first planar portion 21a to the projected area A21 of the first major surface 21 may be at least 0.8, or at least 0.85, or at least 0.90, or at least 0.95, or at least 0.98, or at least 0.99.

In some embodiments, the total projected area A21a of the at least one first planar portion 21a may be less than the total projected area A22a+A22b+A22c of the at least one second planar portion 22a+22b+22c. In some embodiments, the total projected area A21a of the at least one first planar portion 21a and the total projected area A22a+A22b+A22c of the at least one second planar portion 22a+22b+22c may be within 30%, or within 25%, or within 20%, or within 15%, or within 10%, or within 5% of each other.

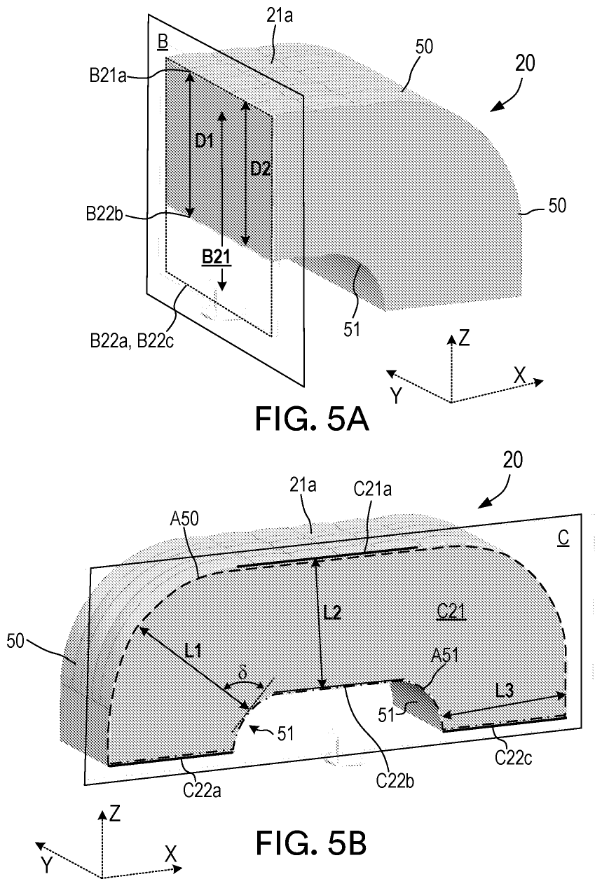

FIGS. 5A and 5B provide cutaway views of an embodiment for a lens for a phased array antenna, and supplement the details discussed for FIGS. 4A and 4B elsewhere herein. It shall be assumed that like-numbered elements common to FIGS. 4A-4B and 5A-5B shall have the same function unless otherwise noted.

FIG. 5A shows lens 20 being bisected by a bisecting plane B that is orthogonal to the reference plane (e.g., the xy-plane defined in FIG. 5A) which bisects the plane along the width direction of lens 20 (e.g., see width direction W of FIG. 3A). FIG. 5B shows an alternate view of lens 20 being bisected by a bisecting plane C that is orthogonal to the reference plane (e.g., the xy-plane) and orthogonal to the B plane of FIG. 5A, which bisects the plane along the length direction of lens 20 (e.g., see length direction L of FIG. 3A).

In some embodiments, lens 20 includes an at least one first planar surface portion 21a and an at least one second planar surface portion 22a, 22b, 22c. In some embodiments, when lens 20 is projected onto a bisecting plane (e.g., bisecting plane B or C) that is orthogonal to the reference plane and substantially bisects the lens, a ratio of a projected area of the planar surface portion to a projected area of the lens is at most 0.1, or at most 0.05, or at most 0.01, or at most 0.005, or at most 0.001.

For example, in the embodiment shown in FIG. 5A, when first planar surface portion 21a is projected onto bisecting plane B, the area of the projection of first planar surface portion 21a is substantially a line B21a (or a narrow rectangular region). Similarly, the combined area of the projection of second planar surface portions 22a, 22b, and 22c is represented by lines/narrow rectangular regions B22a, B22b, and B22c. That is, the total projected area of planar surface portion 21a is a relatively small portion (e.g., at most 0.1) of the overall area of the projection of lens 20 onto bisecting plane B, represented by area B21 in FIG. 5A.

Similarly, in FIG. 5B, when first planar surface portion 21a is projected onto bisecting plane C, the area of the projection of first planar surface portion 21a is substantially a line or narrow rectangular region C21a. The combined area of the projection of second planar surface portions 22a, 22b, and 22c is represented by lines/narrow rectangular regions C22a, C22b, and C22c. That is, the total projected area of each planar surface portion 22a-22c is a relatively small portion (e.g., at most 0.1) of the overall area of the projection of lens 20 onto bisecting plane C, represented by area C21 in FIG. 5B. In some embodiments, for each of the first 21a and second 22a-22c planar surface portions, when projected onto the bisecting plane B or C, the projected area of the planar surface portion onto the bisecting plan is substantially zero.

Looking at the embodiments of FIGS. 5A and 5B, lens 20 includes a first major surface 50 (i.e., the entire outward-facing surface, facing away from the antenna elements) and a second major surface 51, facing the antenna elements. In some embodiments, such as the embodiments of FIGS. 5A and 5B, in at least one of the first and second cross-sectional planes B, C, the first and second major surfaces are curved. In some such embodiments, the first 50 and second 51 major surfaces are substantially parallel with each other. In other such embodiments, in one of the first and second cross-sectional planes, the first 50 and second 51 major surfaces are curved (e.g., they are curved in bisecting plane C), and in the other one of the first and second cross-sectional planes B, C, the first 50 and second 51 major surfaces are substantially straight lines (e.g., the surfaces appear as straight lines in bisecting plane B).

In some embodiments, in each of the first B and second C cross-sectional planes, a length (e.g., lengths D1 and D2 in cross-sectional plane B, and lengths L1, L2, L3 in cross-sectional plane C) of a line that extends between, and is normal to at least one of, the first 50 and second 51 major surfaces, varies by less than 20%, or less than 15%, or less than 10%, or less than 5% across at least of the first and second major surfaces. Stated another way, in some embodiments, the first major surface 50 and second major surface 51 remain substantially parallel throughout the surfaces, even when the surfaces are curved as shown in FIGS. 5A and 5B.

In some embodiments, in each of the first B and second C cross-sectional planes, a length (e.g., D1, D2 in cross-sectional plane B, L1, L2, L3 in cross-sectional plane C) of a line that extends between, and is normal to at least one of, the first and second major surfaces, varies by less than 20%, or less than 15%, or less than 10%, or less than 5% across at least of the first 50 and second 51 major surfaces. In some embodiments, the phased array antenna 100 may be configured to emit a beam at an operating wavelength corresponding to an operating frequency in a range from about 0.5 GHz to about 400 GHz, and wherein the length (e.g., D1, D2, L1, L2, L3) is in a range from about 1.5 times the operating wavelength to about 5 times the operating wavelength. In some embodiments, the operating wavelength may be a free-space operating wavelength. In some embodiments, the operating wavelength may be an operating wavelength in a medium other than air. In some embodiments, the length (e.g., D1, D2, L1, L2, L3) may be a half-integer multiple of the operating wavelength.

For the purposes of this specification, the operating wavelength (corresponding to the operating frequency) may be calculated based on the medium as follows:

$$λ\_medium := \frac{λ\_air}{\sqrt{{ε}_{r \_ medium}}}$$

Where:

$${ε}_{r \_ medium} = Dielectric constant of the medium$$

In the embodiment where the medium is air, the dielectric constant used in the denominator of the equation may be the dielectric constant of air:

$${ε}_{r \_ air} = Dielectric constant of air = 1$$

In some embodiments, the first major surface 50 has at least one substantially first planar surface portion 21a, wherein when projected onto the second cross-sectional plane C, a ratio of a projected area C21a of the at least one substantially first planar surface portion C21 to a projected area A50 (dashed line in FIG. 5B) of the first major surface 50 is at least 0.15, or at least 0.2, or at least 0.25, or at least 0.3, or at least 0.35, or at least 0.4, or at least 0.45, or at least 0.5.

In some embodiments, second major surface 51 has at least one substantially second planar surface portion 22a, 22b, 22c, wherein when projected onto the second cross-sectional plane C, a ratio of a projected area C22a+C22b+C22c of the at least one substantially second planar surface portion 22a, 22b, 22c to a projected area A51 (dash-dot line in FIG. 5B) of the second major surface 51 is at least 0.25, or at least 0.3, or at least 0.35, or at least 0.4, or at least 0.45, or at least 0.5, or at least 0.6, or at least 0.7, or at least 0.8, or at least 0.9.

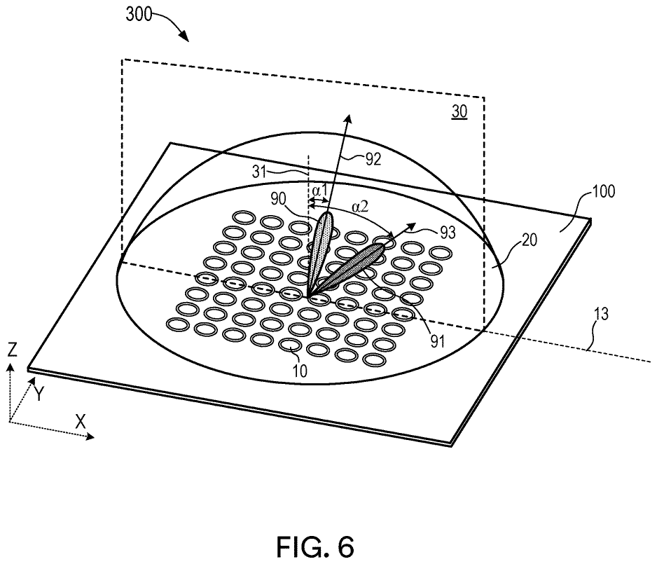

FIG. 6 is a perspective view of an embodiment of a phased array antenna including a lens, according to the present description. It should be noted that FIG. 6 is provided to facilitate a general discussion of the emission and gains of beams emitted by antenna elements to support the present description and is not intended to be accurate in scale or exact implementation. For example, lens 20 in FIG. 6 is a general concept of a lens and is shown as a hemispherical lens typical of the prior art rather than an embodiment of a lens such as those shown in FIGS. 2 through 5B. This is done to better illustrate the antenna elements and beams beneath the lens that are a part of the following discussion and is not meant to be limiting. An embodiment of a lens such as lens 20 of FIGS. 2 through 5B may be inserted in place of the general lens representation shown in FIG. 6.

FIG. 6 shows an embodiment of an antenna assembly 300 including a phased array antenna 100 having a plurality of spaced apart antenna elements 10 arranged in a plurality of rows and columns of the antenna elements 10 and defining a first axis of symmetry 13, and a lens 20 disposed on the phased array antenna 100 and substantially covering at least some of the antenna elements 10.

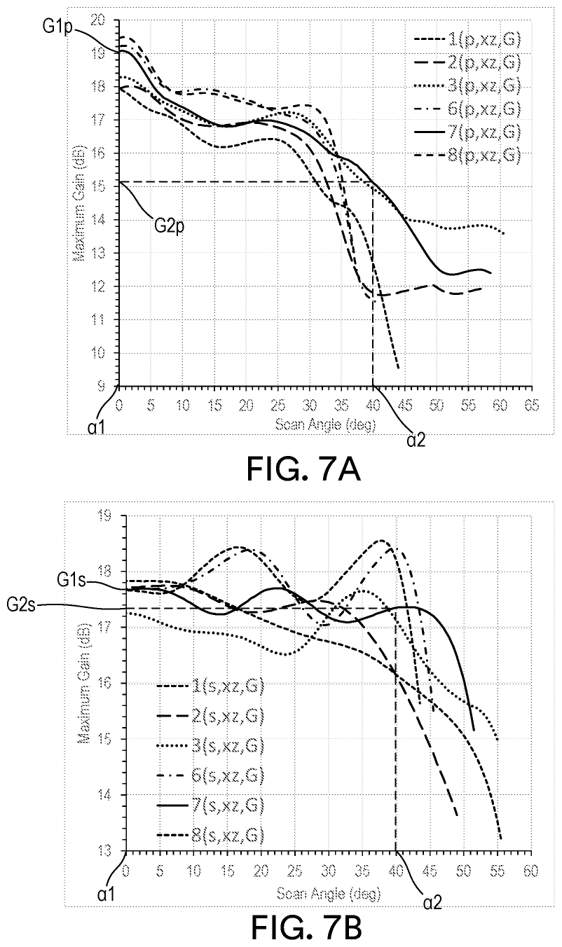

In some embodiments, in a scan plane 30 that comprises the first axis of symmetry 13 and a normal 31 (e.g., a normal following the z-axis shown in FIG. 6) to the phased array antenna 100, the antenna assembly 300 steers respective p-polarized beam 90 and s-polarized beam 91 in the scan plane 30 having respective maximum gains G1p and G1s when steered along a first direction 92 making an angle α1 of less than about 10 degrees, or less than about 8 degrees, or less than about 6 degrees, or less than about 4 degrees, or less than about 2 degrees, or less than about 1 degree (e.g., about 0 degrees) with normal 31 and respective maximum gains G2p and G2s when steered along a second direction 93 making an angle α2 of no less than about 30 degrees, or no less than about 35 degrees, or no less than about 40 degrees with the normal 31. In some embodiments, G2s may be less than G1s by at most about 1 dB, or at most about 0.9 dB, or at most about 0.8 dB, or at most about 0.7 dB, or at most about 0.6 dB, or at most about 0.5 dB, or at most about 0.4 dB, or at most about 0.3 dB, or at most about 0.2 dB, or at most about 0.1 dB (e.g., about 0.4 dB). In some embodiments, G2p may be less than G1p by at least about 1 dB, or at least about 1.5 dB, or at least about 2 dB, or at least about 2.5 dB, or at least about 2.6 dB, or at least about 3 dB, or at least about 4 dB, or at least about 5 dB, or at least about 6 dB, or at least about 7 dB (e.g., about 4 dB). Additional detail on the gains discussed above are provided in the discussion of FIGS. 7A and 7B elsewhere herein.

In some embodiments, the phased array antenna 100 may be configured to emit a beam 90, 91 at an operating wavelength corresponding to an operating frequency in a range from about 0.5 GHz to about 400 GHz. In some such embodiments, an average spacing between the lens 20 and the spaced apart antenna elements 10 of the phased array antenna 100 is between about 5% and about 100% of the operating wavelength in a free space. In some embodiments, an average spacing between the lens 20 and the spaced apart antenna elements 10 of the phased array antenna 100 may be between about 0.01 mm and about 100 mm, or between about 1 mm to about 10 mm. (See also spacing D in FIG. 2.)

In some embodiments, the phased array antenna 100 may be configured to emit a beam 90, 91 at an operating wavelength corresponding to an operating frequency in a range from about 0.5 GHz to about 400 GHz. In some such embodiments, the length of lens 20 may be in a range from about 1.5 times the operating wavelength to about 5 times the operating wavelength. (See also length L in FIG. 3A.)

FIGS. 7A and 7B provide plots for maximum gain versus scan angle for a phased array antenna including a lens. The maximum gain values G1p, G1s, G2p, and G2s discussed elsewhere herein are shown on the graphs of FIGS. 7A and 7B. Each of these figures plots the maximum gain values in decibels (dB) for 6 different lens configurations, with each plot line representing a different lens design. Of particular interest to the present description are plotlines 2 and 7 on each of FIGS. 7A and 7B. Plotline 2 represents the maximum gain values versus scan angle for a typical hemispherical lens of the prior art (such as the generalized lens featured in FIG. 6), and plotline 7 (the solid line) represents the maximum gain values versus scan angle for a lens such as the embodiment of lens 20 of at least FIGS. 2, 3A-3B, 4A-4b, and 5A-5B. FIG. 7A shows plots for a p-polarized beam (e.g., p-polarized beam 90 of FIG. 6) and FIG. 7B shows plots for an s-polarized beam (e.g., s-polarized beam 91 of FIG. 6). The plots show values taken in the xz plane, such as scan plane 30 in FIG. 6.

As discussed elsewhere herein, and as shown in FIGS. 7A and 7B, the antenna assembly steers respective p- and s-polarized beams in the scan plane (xz-plane) having respective maximum gains G1p (FIG. 7A) and G1s (FIG. 7B) when steered along a first direction making an angle α1 of about 0 degrees with the normal, and respective maximum gains G2p (FIG. 7A) and G2s (FIG. 7B) when steered along a second direction making an angle α2 of about 40 degrees with the normal. As shown in the graphs of FIGS. 7A and 7B, G2s is less than G1s by about 0.4 dB and G2p is less than G1p by about 4 dB.

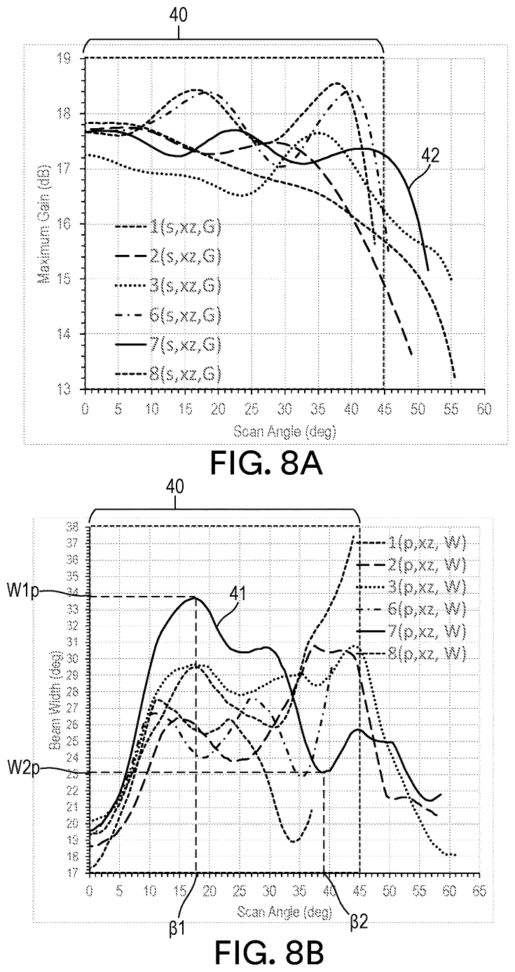

Finally, FIGS. 8A and 8B provide plots for maximum gain and beam width versus scan angle for a phased array antenna including a lens according to the present description. As with FIGS. 7A and 7B, FIGS. 8A and 8B show plotlines for six different lens configurations, including line 2 representing a hemispherical lens of the prior art and line 7 representing a lens such as the embodiment of lens 20 of at least FIGS. 2, 3A-3B, 4A-4b, and 5A-5B. FIG. 8A plots maximum gain values in dB for s-polarized beams versus scan angle for the six lens designs, and FIG. 8B shows beam width values in degrees versus scan angle for p-polarized beams.

As shown in these plots, when the lens is disposed on the phased array antenna, then for an s-polarized beam (such as beam 91 in FIG. 6) steered in a scan plane (the xz-plane or plane 30 in FIG. 6) and for scan angles in a first scan angle range 40 extending from about zero degrees to at least about 45 degrees (see FIG. 8A), a maximum gain of the s-polarized steered beam has an average value Gavg (e.g., about 17.41 shown in Table 1) and a standard deviation Gstd (e.g., about 0.2 shown in Table 1), as summarized in Table 1 below, such that the ratio of Gstd/Gavg is less than or equal to about 0.04, or about 0.035, or about 0.03, or about 0.025, or about 0.02, or about 0.015, or about 0.01 (e.g., about 0.01 shown in Table 1).

TABLE 1
Summary of Gain and Standard Deviation Values (Lines 2 and 7)

| | 7(s, xz, G) | 2(s, xz, G) |
|---|---|---|
| Average (0-45 degrees): | 17.41 | 17.16 |
| Standard Deviation (0-45 deg): | 0.20 | 0.70 |
| Standard Deviation/Average: | 0.01 | 0.04 |

As shown in FIG. 8B, for a p-polarized beam (e.g., beam 90, FIG. 6) steered in the scan plane and for scan angles in the first scan angle range 40, a plot 41 of a beam width of the p-polarized steered beam as a function of the scan angle has a first beam width Wp1 at a smaller first scan angle β1 of greater than about 5 degrees, or greater than about 10 degrees, or greater than about 15 degrees (e.g., about 17.5 degrees in FIG. 8B) and a second beam width Wp2 at a larger second scan angle β2 of greater than about 20 degrees, or greater than about 25 degrees, or greater than about 30 degrees, or greater than about 35 degrees (e.g., about 39 degrees, FIG. 8B), Wp1 greater than Wp2 by at least 5 degrees, or at least 6 degrees, or at least 7 degrees, or at least 8 degrees, or at least 9 degrees, or at least 10 degrees (e.g., about 11 degrees, FIG. 8B). In some embodiments, the first beam width Wp1 at the smaller first scan angle may be a global maximum of the plot of the beam width of the p-polarized steered beam as a function of the scan angle.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A lens configured to be disposed on and substantially cover a plurality of spaced apart antenna elements of a phased array antenna, the lens comprising;
a first major surface configured to face away from the antenna elements and an opposite second major surface configured to face the antenna elements, the first and second major surfaces comprising substantially planar and substantially parallel respective at least one first and at least one second planar portions; and
opposite first and second end portions extending from the second major surface toward the first major surface and joining the first major surface by opposing respective first and second joining portions,
such that when projected onto a reference plane that is substantially parallel to the at least one first and the at least one second planar portions:
a ratio of a total projected area of the at least one first planar portion to a projected area of the lens is at least 0.15; and
a ratio of a total projected area of the at least one second planar portion to the projected area of the lens is at least 0.1.

2. The lens of claim 1, wherein the ratio of the total projected area of the at least one second planar portion to the projected area of the second major surface is at least 0.8.

3. The lens of claim 1, wherein the ratio of the total projected area of the at least one first planar portion to the projected area of the first major surface is at most 0.9.

4. The lens of claim 1, wherein the ratio of the total projected area of the at least one first planar portion to the projected area of the first major surface is at least 0.8.

5. The lens of claim 1, wherein the total projected area of the at least one first planar portion is less than the total projected area of the at least one second planar portion.

6. The lens of claim 1, wherein the total projected area of the at least one first planar portion and the total projected area of the at least one second planar portion are within 30% of each other.

7. The lens of claim 1, wherein the first and second major surfaces define a height direction of the lens therebetween, and wherein the first and second end portions define a length direction of the lens therebetween, the length and height directions orthogonal to each other.

8. The lens of claim 7, wherein a maximum height of the lens along the height direction is less than a maximum length of the lens along the length direction.

9. The lens of claim 7 further comprising opposing first and second side portions extending between the first and second major surfaces and between the first and second end portions, wherein the first and second side portions are substantially planar and substantially parallel to each other.

10. The lens of claim 7, wherein the first and second side portions define a width direction of the lens therebetween orthogonal to the height and length directions, wherein a maximum width of the lens along the width direction is less than a maximum length of the lens along the length direction.

11. The lens of claim 1, wherein the phased array antenna is configured to emit a beam at an operating frequency in a range from about 0.5 GHz to about 400 GHz, and wherein a dielectric constant of the lens is in a range from 1.2 to about 7 at the operating frequency.

12. The lens of claim 1, wherein the phased array antenna is configured to emit a beam at an operating wavelength, wherein each of the first and second joining portions is curved having a radius of curvature, and wherein the radius of curvature is between about 1.5 times the operating wavelength to about 3 times the operating wavelength.

13. The lens of claim 12, wherein the radius of curvature is about 2.5 times the operating wavelength.

14. A lens (20) configured to be disposed on and substantially cover a plurality of spaced apart antenna elements (10) of a phased array antenna (100), the lens comprising;
at least one substantially first planar surface portion (21a) defining at least one corresponding first reference plane (xy-plane) and configured to face away from the antenna elements; and
at least one substantially second planar surface portion (22a, 22b, 22c) defining at least one corresponding second reference plane (xy-plane) and configured to face the antenna elements, such that for each of the first and second planar surface portions:
when projected onto the reference plane corresponding to the planar surface portion, a ratio of a projected area of the planar surface portion (A21a, A22a, A22b, A22c) to a projected area of the lens (A21) is at least 0.15 (or 0.2, or 0.25, or 0.3, or 0.35, or 0.4, or 0.45, or 0.5); and
when projected onto a bisecting plane (B, C) that is orthogonal to the reference plane and substantially bisects the lens, a ratio of a projected area of the planar surface portion (B21a, B22a, B22b, B22c; C21a, C22a, C22b, C22c) to a projected area of the lens (B21; C21) is at most 0.1 (or 0.05, or 0.01, or 0.005, or 0.001).

15. The lens of claim 14, wherein for each of the first and second planar surface portions, when projected onto the bisecting plane, the projected area of the planar surface portion onto the bisecting plan is substantially zero.

16. A lens configured to be disposed on and substantially cover a plurality of spaced apart antenna elements of a phased array antenna, the lens comprising opposing first and second major surfaces, such that in each of mutually orthogonal first and second cross-sectional planes that substantially bisect the lens along mutually orthogonal respective first and second directions, the first and second major surfaces are substantially parallel with each other.

17. The lens of claim 16, wherein in at least one of the first and second cross-sectional planes, the first and second major surfaces are curved.

18. The lens of claim 16, wherein one of the first and second cross-sectional planes, the first and second major surfaces are curved, and in the other one of the first and second cross-sectional planes, the first and second major surfaces are substantially straight lines.

19. The lens of claim 16, wherein in each of the first and second cross-sectional planes, a length of a line that extends between, and is normal to at least one of, the first and second major surfaces, varies by less than 20% across at least of the first and second major surfaces.

20. The lens of claim 19, wherein the phased array antenna is configured to emit a beam at an operating wavelength corresponding to an operating frequency in a range from about 0.5 GHz to about 400 GHz, and wherein the length is in a range from about 1.5 times the operating wavelength to about 5 times the operating wavelength.

21.-31. (canceled)
